(19) United States
(12) Patent Application Publication
(10) Pub. No.: US 2004/0204079 A1
(43) Pub. Date: Oct. 14, 2004

(54) Dual access wireless LAN system

(75) Inventor: Rabah S. Hamdi, Spring, TX (US)

Correspondence Address: INTELLECTUAL PROPERTY ADMINISTRATION, LEGAL DEPARTMENT, M/S35, P.O. BOX 272400, FT COLLONS, CO, 80527-2400, US

(73) Assignee: Compaq Information Technologies Group, L.P., Houston, TX (US)

(21) Appl. No.: 10/261,100

(22) Filed: Sep. 30, 2002

(51) Int. Cl. H04M 1/00; H04B 1/38

(52) U.S. Cl. 455/557; 455/556.1

(57) ABSTRACT

A wireless local area network (LAN) includes various devices, both hard-wired devices and wireless devices that allow communications between the devices and possibly to other devices in other networks, such as private computer networks and the Internet. The present invention allows wireless devices to sense and access various types of wireless networks, including IEEE 802.11a, 802.11b and 802.11g networks. Access to the wireless networks can be made with or without user intervention. The present invention provides an efficient and versatile means for wireless devices to communicate with other devices in a network.

### CROSS-REFERENCE TO RELATED APPLICATIONS

Not Applicable.

### STATEMENTS REGARDING FEDERALLY SPONSORED RESEARCH OR DEVELOPMENT

Not Applicable.

### REFERENCE TO A MICROFICHE APPENDIX

Not Applicable.

### BACKGROUND OF THE INVENTION

1. Field of the Invention

The present invention generally relates to wireless devices accessing a network, in particular wireless devices accessing a plurality of networks, including IEEE 802.11a, 802.11b and 802.11g local area networks (LAN).

2. Description of the Related Art

To improve mobility of devices connected to a network, many devices today employ wireless technologies to communicate with other devices in the network. Wireless network standards have been formed and implemented to meet the needs of mobile users.

One such network standard is the Institute of Electrical and Electronic Engineer's (IEEE) standard 802.11. 802.11 refers to a family of specifications developed by the IEEE for wireless LAN technology. 802.11 specifies an over-the-air interface between a wireless client and a base station or between two wireless clients. The IEEE accepted the specification in 1997.

There are several specifications in the 802 family including first, 802.11. IEEE 802.11 applies to wireless LANs and provides 1 or 2 Mbps transmission in the 2.4 GHz band using either frequency hopping spread spectrum (FHSS) or direct sequence spread spectrum (DSSS).

IEEE 802.11a is an extension to 802.11 that applies to wireless LANs and provides up to 54 Mbps in the 5 GHz band. IEEE 802.11a uses an orthogonal frequency division multiplexing encoding scheme rather than FHSS or DSSS.

IEEE 802.11b (also referred to as 802.11 High Rate) is an extension to 802.11 that applies to wireless LANs and provides 11 Mbps transmission (with a fallback to 5.5, 2 and 1 Mbps) in the 2.4 GHz band. IEEE 802.11b uses only DSSS. IEEE 802.11b was a 1999 ratification to the original 802.11 standard, allowing wireless functionality comparable to Ethernet networks.

Another IEEE 802.11 variation is IEEE 802.11g. IEEE 802.11g applies to wireless LANs and provides 24+ Mbps in the 2.4 GHz band.

Network designers generally choose a particular network standard based on the environmental concerns of the network, including location and noise; number of users, speed; and cost. Sometimes, a particular user (or client) may be located in a geographical area where more than one wireless network standard exists.

Although the user may wish to access different networks, wireless devices today typically are designed to operate in a particular network environment, e.g., 802.11a. Consequently, the user is limited to accessing a particular network.

### BRIEF SUMMARY OF THE INVENTION

Briefly, an apparatus and method for allowing wireless devices to access and communicate with networks employing different network standards. The wireless device can be incorporated in various interface devices, such as a Network Interface Card (NIC), a Universal Serial Bus (USB) card, a Personal Computer Memory Card International Association (PCMCIA) card or an access point in a wired LAN.

For example, a computer laptop user can typically access a network if the laptop is connected to the network. One such method of connection is if the laptop is hard-wired (e.g., a Category 5 Ethernet cable) to the network. Another method may be a wireless connection where the computer laptop includes a PCMIA NIC card that provides the wireless interface between the client (i.e., computer laptop) and a base station. The base station in a wireless network is typically an access point (AP). One function of the access point is to form a communication bridge between a wired and wireless network.

The wireless network generally adheres to a communication's standard, such as the Institute of Electrical and Electronic Engineer's (IEEE) 802.11 family of standards. The IEEE 802.11 family of standards includes IEEE 80211a, 802.11b and 802.11g. One embodiment provides the necessary hardware and software to allow the client to automatically or manually access either wireless networks without having redundant standard specific hardware and software.

Another embodiment includes a software defined radio that includes programmable digital signal processors (DSP) for transmitting and receiving wireless data in either defined IEEE 802.11 modes. Furthermore, a power management function is available to conserve power when data is not received nor is to be transmitted.

### BRIEF DESCRIPTION OF THE SEVERAL VIEWS OF THE DRAWINGS

A better understanding of the present invention can be obtained when the following detailed description of some embodiments is considered in conjunction with the following drawings in which:

FIG. 1 is a block diagram of a prior art wireless local area network (WLAN).

FIG. 2 is a block diagram of an exemplary WLAN.

FIG. 3 is a block diagram of a prior art wireless NIC.

FIG. 4 is a block diagram of an exemplary baseband portion of a wireless NIC.

FIG. 5 is a block diagram of an exemplary RF portion of a wireless NIC.

FIG. 6 is a block diagram of an exemplary software radio defined transmitter receiver.

FIG. 7 is a flowchart of an exemplary technique for accessing a plurality of network modes.

FIG. 8 is a flowchart of an exemplary technique for accessing a plurality of network modes using power management features.

### DETAILED DESCRIPTION OF THE INVENTION

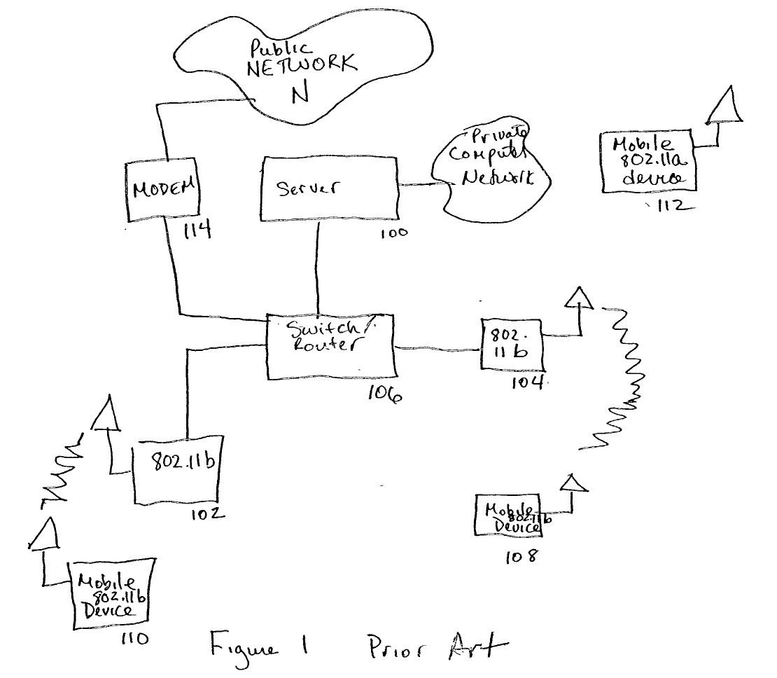

Turning to FIG. 1, a prior art system includes a server 100, a plurality of access points 102, 104, a router/switch 106, and a plurality of mobile devices 108, 110.

The server 100 is coupled to the router/switch 106. The server 100, the plurality of access ports 102, 104, the router/switch 106 and the plurality of mobile devices 108, 110 can comprise a local area network (LAN) N. The LAN N can be coupled to a public computer network, such as the Internet via a modem 114 or a private computer network via the server 100.

In this embodiment, the mobile devices 108, 110 are coupled to the LAN N via wireless connections Y, Z to the access points 102, 104. The access points 102, 104 are hardwired to the LAN N. The wireless connections Y, Z allows the mobile device 108, 110 to roam freely within a certain distance from the access points 102, 104.

To maintain uniformity, the prior art LAN N generally conforms to a standard. A popular standard for a LAN N is a IEEE 802.3 Ethernet standard. This standard typically provides specifications for the Medium Access Control (MAC) layer and Physical (PHY) layer for various devices in the LAN N.

The access points 102, 104 generally form bridges between the mobile wireless devices 108, 110 and the wired LAN devices, such as the router 106 and the server 100. Typically, all communications between mobiles devices and the wired LAN go through the access points 102, 104. The access points 102, 104 are not typically mobile, but form part of the wired LAN infrastructure.

Wireless communications between the mobile devices 108, 110 and the wired LAN occur via the access points 102, 104. As with the wired LAN, the wireless mobile devices 108, 110, generally adhere to a single communication standard, such as IEEE 802.11b. The IEEE 802.11b standard includes transmission of signals at 2.4 GHz with certain power requirements.

In addition, the IEEE 802.11b standard includes handshaking/encryption/communication protocols. Thus, only devices adhering to the standard may communicate with one another. Thus, in the prior art system in FIG. 1, a mobile device 112 cannot communicate with the LAN because it does not adhere to the 802.11b standard.

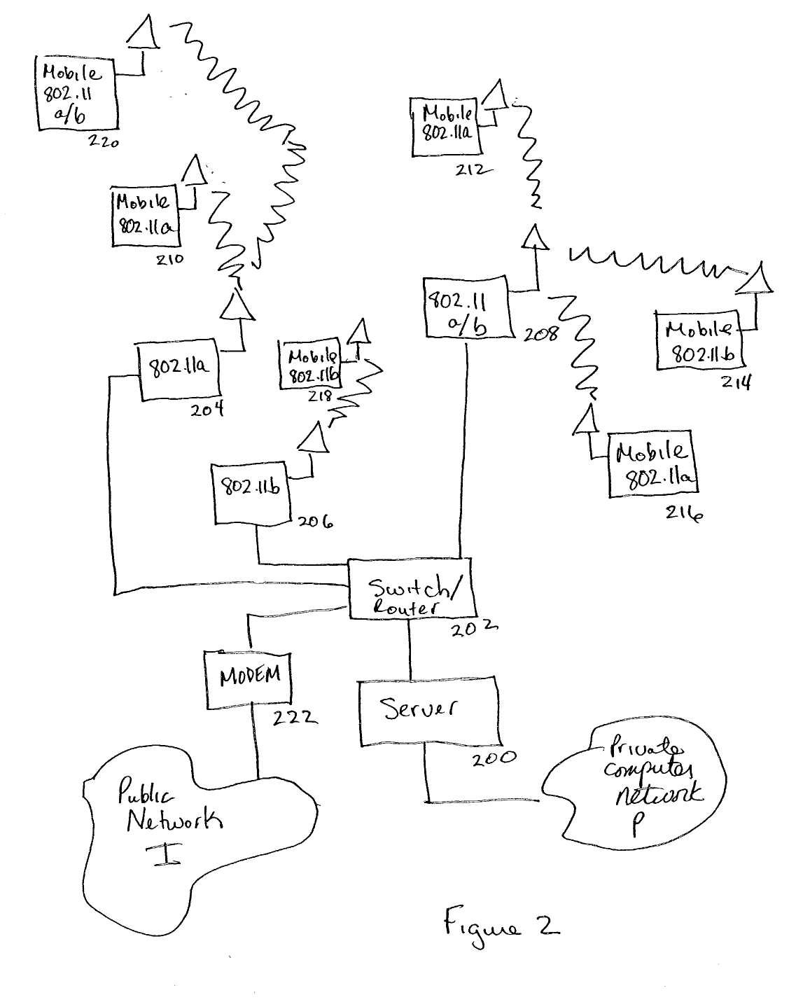

FIG. 2 illustrates an exemplary LAN. A LAN comprises a server 200, a router/switch 202 and access points 204, 206, 208. The access point 204 and the access point 206 conforms to the IEEE 802.11a and IEEE 802.11b or 802.11g standards, respectively. The IEEE 802.11a standard is another type of wireless LAN standard. This standard operates in the 5 GHz frequency band. Thus, in this figure, the mobile device 210 cannot communicate with the wired LAN via the access point 206, since the mobile device 210 and the access point 206 adhere to different standards. Likewise, the mobile device 218 cannot communicate with the access point 204, since they both adhere to different standards.

The access point 208 can operate under IEEE 802.11a, 802.11b or 802.11g standards. The access point 208 includes hardware and software for a plurality of mode operations. Thus, the mobile device 212 which is configured for IEEE 802.11a communications can communicate with the wired LAN via the accessible access point 208. Furthermore, the mobile device 214 that adheres to the IEEE 802.11b standard can communicate with the LAN via the same access point 208. The plurality of mode accessible access point 208 allows for increased versatility and conformability with devices that adhere to the IEEE 802.11 family, such as the IEEE 802.11a, 802.11b or 802.11g standards.

Besides multiple mode functionality in the access points, the mobile device 220 can include hardware/software that can operate in either 802.11a, 802.11b 802.11g environments. Thus, in this figure the mobile device 220 would monitor the environment for the nearest access point. In this figure, the access point 204 is closest to the mobile device 220. Since the access point adheres to the IEEE 802.11a standard, the mobile device 220 would sense such standard and configure itself to be able to communicate with the access point. Although not shown, the mobile devices can include a Network Interface Card (NIC). The NIC could be plugged into a laptop computer for wireless access to the computer networks, such as the Internet I, or a private computer network P.

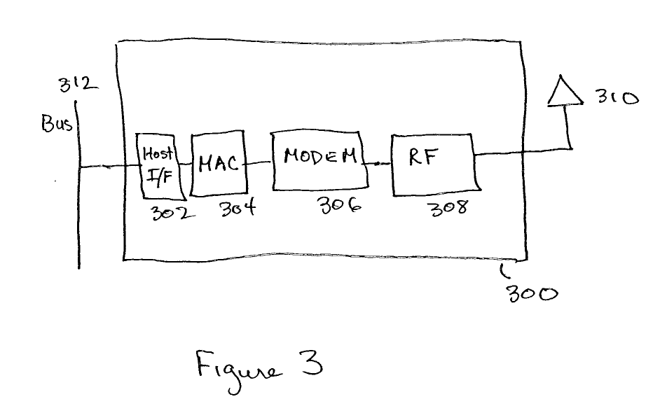

FIG. 3 illustrates a prior art NIC for wireless access to a network. The NIC 300 includes a host interface (I/F) 302, a media access controller (MAC) 304, a modem 306, a RF transmitter/receiver 308 and an antenna 310.

The NIC 300 is coupled to a processor (not shown) via a bus 312. The bus 312 be any standard data bus such as a Universal Serial Bus (USB), a Peripheral Component Interconnect (PCI) bus, a Compact Flash (CF) bus or a Personal Computer Memory Card International Association (PCMCIA) bus. The MAC 304 provides the necessary control functions of the NIC 300. The modem 306 modulates outgoing data and demodulates incoming data for the NIC 300. The RF 308 and the antenna 310 provide the necessary means for transmitting and receiving wireless data to a network (not shown), such as a LAN. Prior art NICs are configured for one standard, such as IEEE 802.11a. Consequently, the prior art NIC cannot communicate in a dual standard mode.

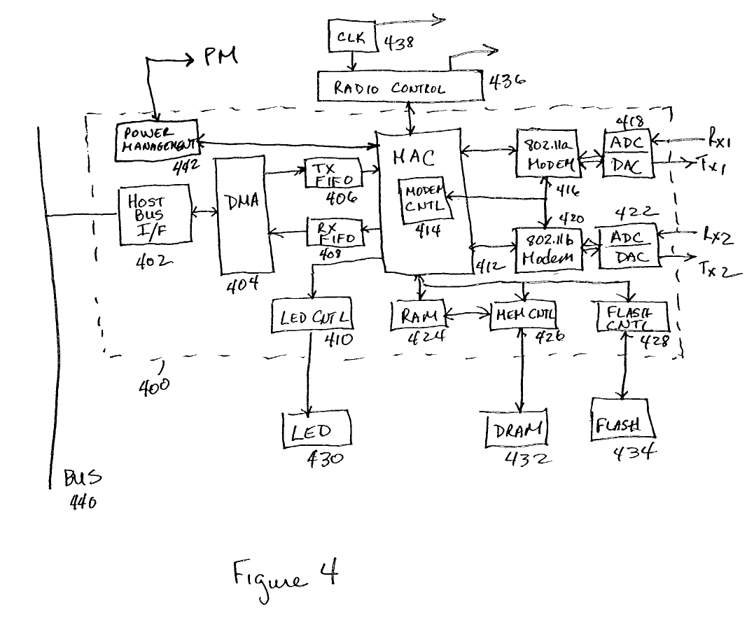

Turning to FIG. 4, a baseband section of a NIC, includes a host, MAC and modem, collectively 400, of the present invention is illustrated. The NIC interfaces with a processor (not shown) via an I/F 402 and a bus 440. The bus 440 can be any type of bus, such as a PCI bus, a USB bus, a CF bus or a PCMCIA bus. The I/F 402 is coupled to a media access controller (MAC) 412 via a DMA 404 and transmit (TX) and receive (RX) FIFOs 406 and 408. The MAC 412 includes a modem controller 414. The MAC 412 is coupled to a radio control 436, modems 416, 420, a LED controller 410, RAM 424, a memory controller 426 and a flash controller 428. The MAC 412 can provide status in the form of light indicators via LED 430 as controlled by the LED controller 410. The MAC 412 can access the RAM 424 and additional memory, such as DRAM 432 or flash memory 434, via the memory controller 426 and the flash controller 428.

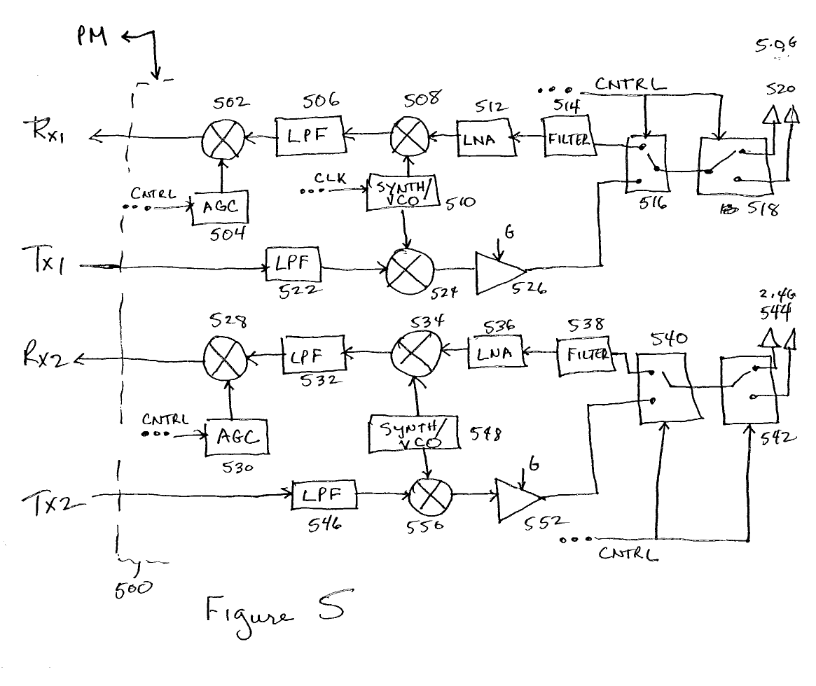

The radio control 436 is clocked by a clock 438. The radio control 436 controls the RF functions of the NIC. The modem 416 adheres to the IEEE 802.11a standard while the modem 420 adheres to the IEEE 802.11b and/or 802.11g standards. Both modems 416, 420 are controlled by the MAC's modem controller 414. Each modem 416, 420 is coupled to its respective analog/digital converters 418, 422. The converters 418, 422 are coupled to the RF section of the NIC (see FIG. 5) for transmission/reception with a LAN.

FIG. 5 illustrates the RF section of a NIC, according to the present invention. The RF section 500 includes the necessary hardware for transmitting/receiving IEEE 802.11a, 802.11b or 802.11g data. The 802.11a standard operates in the 5 GHz band while the 802.11b and 802.11g standards operate in the 2.4 GHz band.

Baseband data from the baseband section of the NIC 400 is shown in FIG. 5 as Rₓ₁, Tₓ₁ processing 5 GHz signals such as IEEE 802.11a signals and as Rₓ₂, Tₓ₂ processing 2.4 GHz signals such as IEEE 802.11b or 802.11g signals.

For example, when the NIC is operating in the IEEE 802.11a mode, transmitting data is filtered by a Low Pass Filter (LPF) 522 and is modulated to the 5.0 GHz band by a modulator 524 and a synthesizer/VCO 510. The synthesizer/VCO 510 is clocked by the CLK signal (see FIG. 4). The modulated signal is amplified by gain G via an amplifier 526. The control signal CNTRL from the radio control 436 outputs the modulated signal to a pair of diversity antennas 520 via devices 516, 518. The diversity antennas are tuned to operate in the 5 GHz band. The diversity antennas 520 also generally provide for directional RF coverage.

Incoming IEEE 802.11a signals are received via the diversity antennas 520. The radio control 436 senses the incoming signal and provides the signals to a filter 514 via the devices 516 and 518. In addition, the radio control 436 detects whether the in-band signal energy is presence at a certain frequency. For example, the radio control 436 may direct the radio section 500 to alternatively scan for 2.4 GHz or 5 GHz signals. If the radio section 500 detects in-band signal energy at approximately 2.4 GHz, the radio control 436 will generally fine tune the receive path of the radio section 500 to process the incoming 2.4 GHz signal. A similar process would occur if the radio section 500 detects in-band signal energy at approximately 5 GHz. The radio control 436 would typically fine tune the receive path of the radio section 500 to process the incoming 5 GHz signals.

The signal is then amplified by a low noise amplifier (LNA) 512 and demodulated to an intermediate signal via the demodulator 508 and the synthesizer/VCO 510. The intermediate signal is filtered by a filter 506 and demodulated to a baseband signal via a modulator 502 and amplified by an automatic gain control (AGC) 504. The AGC 504 is controlled by the radio control 436. The baseband signal is transmitted to the modem 416 via the DAC 418.

IEEE 802.11b or 801.11g processing through the RF section to the modem 420 is illustrated by the Rₓ₂ and Tₓ₂ lines. Diversity antennas 544 are tuned to operate in the 2.4 GHz band. As with the diversity antennas 520, the diversity antennas 544 generally provide for directional RF coverage.

As discussed above, implementation of the dual mode system described herein can be incorporated into a mobile device, such as a laptop computer, cell phone, personnel digital assistant (PDA) or base station of a wired LAN, such as an access point. The dual mode system allows for versatility using common components thus saving precious real estate of a board. In addition, user intervention may not be necessary, once the appropriate wireless mode is detected. That is, a client (laptop user) may not need to manually access a particular network. Once the wireless network is identified, appropriate login information may be transmitted to the access point to allow client access to the LAN.

Furthermore, the embodiments illustrated in FIGS. 4 and 5 can be implemented in a variety of ways, using various components such as application specific integrated circuits (ASICs). One such way is a software radio implementation. Baseband processing can be done by a digital signal processor (DSP). Thus, operation in either IEEE 802.11a, 802.11b or 802.11g modes can be accomplished by a single DSP. Software implementation of bandband functions, such as coding, modulation, equalization and pulse shaping can be accomplished by DSP technology. Thus, reprogrammability of the DSP can ensure multi-standards' operations.

Furthermore, one embodiment includes a power management function. As shown in FIGS. 4 and 5, the MAC 412 is coupled to a power management unit 442. The MAC 412 provides the necessary controls to the power management unit 442 for power management. Such controls include the operation of the NIC 400 in either a low power state or an active state. The power management unit 442 is also coupled to the RF section of the NIC. During periods of inactivity, the NIC 400 may go into a low power state. For example, if the RF section does not receive incoming data for a particular period of time, the power management unit 442 would detect such inactivity via a PM line to the RF section. The power management unit 442 would then send status data to the MAC 412, whereby the MAC 412 may direct the NIC 400 to go into a low power state. During the low power state, the power management unit 442 would continue to monitor the RF section of the NIC to determine whether incoming data is received. Once incoming data is received by the RF section, the power management unit 442 would provide status information to the MAC 412, whereby the MAC 412 may direct the NIC 400 to go into an active state. Likewise, should the NIC 400 receive data for transmission from the bus 440, the power management unit 442 would provide status information to the MAC 412, so that the MAC 412 may direct the NIC 400 to go into an active state.

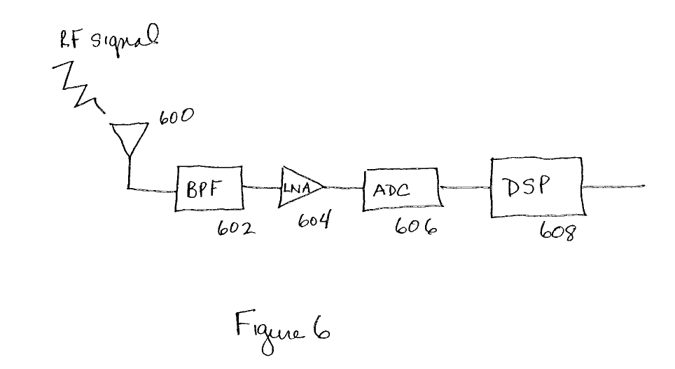

FIG. 6 is a block diagram of a software radio receiver, according to the present invention. Incoming RF signals is received by an antenna 600. The RF signal is filtered and amplified by a band-pass filter 602 and a low noise amplifier 604, respectively. The RF signal is converted to a digital signal via a analog to digital converter 606. Demodulation and other baseband processing can be done by a DSP 608.

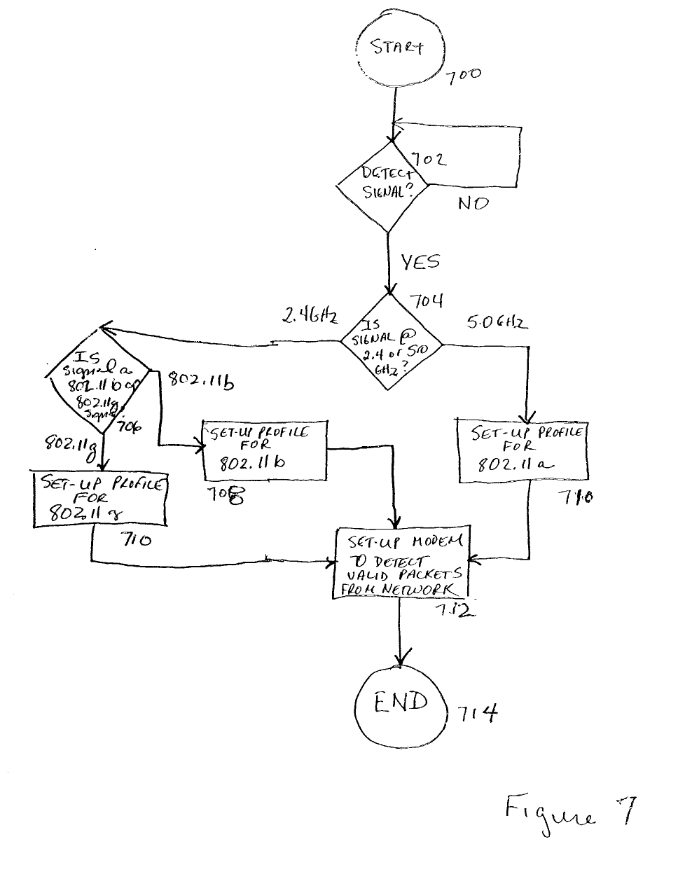

A method according to one embodiement is illustrated in a flowchart in FIG. 7. The method starts at step 700. A signal is detected at step 702. If no signal is detected, the method loops back to step 702. At step 704, if the in-band energy of the signal is in the 5 GHz band, the method proceeds to step 710, where a NIC is set up for IEEE 802.11a operations. If the in-band energy of the signal is in the 2.4 GHz band, the method proceeds to step 706. At step 706, if the signal is a 802.11b signal, then the NIC is set up to operate in the 802.11b mode at step 708, then proceeds to step 712. At step 706, if the signal is a 802.11g signal, then the NIC is set up to operate in the 802.11g mode at step 710. At step 712, a modem is set up to operate in the detected IEEE 802.11 mode. The method ends at step 714.

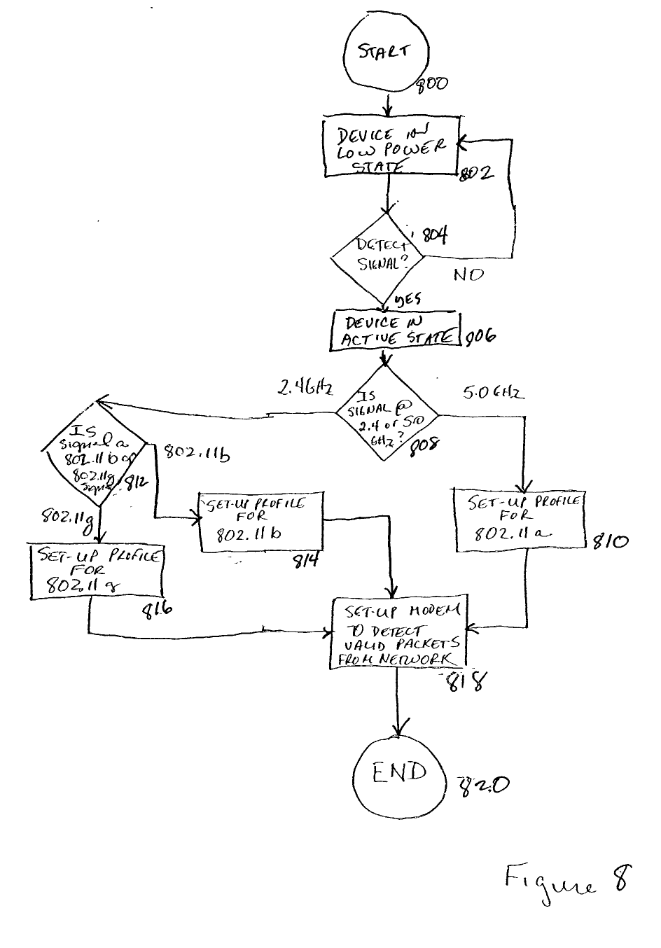

Another method according to one embodiment is illustrated in a flowchart in FIG. 8. The method starts at step 800. A device, such as a NIC, is in the low power state at step 802. A signal is detected at step 804. If a signal is not detected, the method loops back to step 802. If a signal is detected at step 804, the NIC is placed in an active state at step 806. At step 808, if the in-band energy of the signal is in the 5 GHz band, the method proceeds to step 810, where the NIC is set up for IEEE 802.11a operations. At step 808, if the in-band energy of the signal is in the 2.4 GHz band, the method proceeds to step 812. At step 812, if the signal is a 802.11b signal, then the NIC is set up to operate in the 802.11b mode at step 814 and proceeds to step 818. At step 812, if the signal is a 802.11g signal, then the NIC is set up to operate in the 802.11g mode at step 816 and proceeds to step 818. At step 818, a modem is set up to operate in the detected IEEE 802.11 mode. The method ends at step 820.

The foregoing disclosure and description of various embodiments are illustrative and explanatory thereof, and various changes in the system/device configurations, circuit boards, techniques and components, as well as in the details of the illustrated circuitry and software and construction and method of operation may be made without departing from the spirit and scope of the invention.

I claim:

1. A communication system; comprising:
a server coupled to a router;
the router is coupled to a computer network via a modem;
an access point that operates in a single mode and is also coupled to the router; and
a wireless mobile device that operates in a plurality of modes, one of the plurality of modes is the single mode, whereby the wireless mobile device communicates with the computer network via the access point.

2. The system of claim 1, wherein the computer network is the Internet.

3. The system of claim 2, wherein the singe mode adheres to an IEEE 802.11a standard and the plurality of modes includes IEEE 802.11b or IEEE 802.11g standards.

4. The system of claim 3, wherein the wireless mobile device is a laptop computer.

5. The system of claim 3, wherein the wireless mobile device is a cellular phone.

6. The system of claim 3, wherein the wireless mobile device is a personal digital assistant (PDA).

7. The system of claim 3, wherein the wireless mobile device is a network interface card.

8. The system of claim 7, wherein the network interface card can be coupled to a PCI bus.

9. A wireless mobile device comprising:
a processor coupled to a bus;
a plurality of modems coupled to said processor, each modem operates in one of a pre-defined plurality of wireless mode; and
an RF transmitter/receiver coupled to the modem for transmitting and receiving data.

10. The device of claim 9, wherein one modem operates in a pre-determined plurality of wireless mode adhering to a IEEE 802.11a standard and another modem operates in a pre-determined plurality of wireless mode adhering to IEEE 802.11b or IEEE 802.11g standards.

11. The device of claim 10, wherein the RF transmitter/receiver is coupled to a pair of diversity antennas.

12. The device of claim 11, wherein the bus is a Universal Serial Bus (USB) bus.

13. The device of claim 11, wherein the bus is a Personal Computer Memory Card International Association (PCMIA) bus.

14. The device of claim 11, wherein the bus is a Peripheral Component Interconnect (PCI) bus.

15. The device of claim 11, wherein the bus is a Compact Flash (CF) bus

16. The device of claim 11, wherein the bus is an Ethernet bus.

17. The device of claim 11, wherein the modem and the RF transmitter/receiver are implemented in a digital signal processor.

18. A method for operating in a plurality of wireless access modes, comprising the steps of:
detecting a signal;
determining whether the signal is centered at a first frequency band or a second frequency band;
setting up a transmitter/receiver in one of the plurality of wireless access modes based on whether the signal is centered at the first frequency band or the second frequency band; and
setting up a modem to operate in one of the plurality of wireless access modes.

19. The method of claim 18, wherein the signal is a radio frequency (RF) signal.

20. The method of claim 19, wherein the first frequency band is approximately a 5 GHZ band and the second frequency is approximately a 2.4 GHz band.

21. The method of claim 20, wherein the plurality of wireless access modes includes operations adhering to an IEEE 802.11a standard or an IEEE 802.11b standard or an IEEE 802.11g standard.

22. The method of claim 21, wherein if the signal is centered at an approximate 5 GHz band, the one of the plurality of wireless access modes adheres to the IEEE 802.11a standard.

23. The method of claim 21, wherein if the signal is centered at an approximate 2.4 GHz band, the one of the plurality of wireless access modes adheres to the IEEE 802.11b standard or the IEEE 802.11g standard.

24. A method for operating in a plurality of wireless access modes, comprising the steps of:
placing a device in a low power state;
detecting a signal;
determining whether the signal is centered at a first frequency band or a second frequency band;
placing the device in an active state if the signal is centered at the first frequency bank of the second frequency band, otherwise keeping the device in the low power state;
setting up a transmitter/receiver in one of the plurality of wireless access modes based on whether the signal is centered at the first frequency band or the second frequency band; and
setting up a modem to operate in one of the plurality of wireless access modes.

25. The method of claim 24, wherein the device is a Network Interface Card (NIC).

26. The method of claim 25, wherein the first frequency band is approximately a 5 GHZ band and the second frequency is approximately a 2.4 GHz band.

27. The method of claim 26, wherein the plurality of wireless access modes includes operations adhering to an IEEE 802.11a standard or an IEEE 802.11b standard or an IEEE 802.11g standard.

28. The method of claim 27, wherein if the signal is centered at an approximate 5 GHz band, the one of the plurality of wireless access modes adheres to the IEEE 802.11a standard.

29. The method of claim 27, wherein if the signal is centered at an approximate 2.4 GHz band, the one of the plurality of wireless access modes adheres to the IEEE 802.11b standard or the IEEE 802.11g standard.

30. A communication system; comprising:
a server coupled to a router;
the router is coupled to a computer network via a modem;
an access point that operates in a plurality of modes and is also coupled to the router, one of the plurality of modes is a single mode; and
a wireless mobile device that operates in the single mode, whereby the wireless mobile device communicates with the computer network via the access point.

31. The system of claim 1, wherein the computer network is the Internet.

32. The system of claim 31, wherein the singe mode adheres to an IEEE 802.11a standard and the plurality of modes includes IEEE 802.11b or IEEE 802.11g standards.

33. The system of claim 32, wherein the wireless mobile device is a laptop computer.

34. The system of claim 32, wherein the wireless mobile device is a cellular phone.

35. The system of claim 32, wherein the wireless mobile device is a personal digital assistant (PDA).
